(19) United States
(12) Patent Application Publication
(10) Pub. No.: US 2011/0185415 A1
(43) Pub. Date: Jul. 28, 2011

(54) System and method for information exchange by means of web-enabled personal trusted device

(75) Inventor: Leonid Kontsevich, San Francisco, CA (US)

(73) Assignees: Leonid Kontsevich, San Francisco, CA (US); Youriy Drozd, Fremont, CA (US)

(21) Appl. No.: 13/015,547

(22) Filed: Jan. 27, 2011

Related U.S. Application Data
(60) Provisional application No. 61/298,695, filed on Jan. 27, 2010.

(51) Int. Cl. G06F 15/16; H04L 9/32; G06F 21/00

(52) U.S. Cl. 726/9; 709/227

(57) ABSTRACT

A system and method for token-based information dispatch is proposed. The system establishes a link between a user via his/her personal trusted device (PTD) and a Publisher that publishes a request for information exchange in the form of a unique number (token), encoded in optical or radio frequency signal. The user PTD reads said signal, establishes a link with the Publisher, and authorizes exchange of information between the user, the Publisher, and the parties designated by the Publisher.

### FIELD OF THE INVENTION

The invention relates generally to the field of communication and relates specifically to targeted information exchange agreed upon by the parties involved.

### BACKGROUND OF THE INVENTION

When two parties interact to ready for a transaction, they are often required to provide information to the other party or a third party. In most cases it is done by direct exchange: a customer picks a coupon booklet at the store entrance. In some cases the information exchanged is sensitive. Quite often, however, such an approach is inconvenient (as in a large store, where coupons and promotions would better work if offered in right locations: at isles or sections) and insecure (as on websites, where a customer fills forms providing personal information). It would be much more secure and convenient to keep the data on a secure data server, and provide a method for users to authorize such an information exchange.

Such systems, indeed, already exist, but they mostly are limited to the web. PayPal, for instance, while confirming payment, provides a merchant with customer's shipping address, automatically pre-filling related forms with information stored on its servers. OpenID does similar job providing personal information stored on a trusted OpenID server. There is a need in a system that would dispatch information when all parties involved are not necessarily online and which would provide consistent experience for online and offline cases.

### SUMMARY OF THE INVENTION

A system of token-based information exchange meets the need for a system described in the previous section. To perform information exchange a Publisher requests and Token Management Service creates a unique token, which is presented by the Publisher to a user and is scanned by the user PTD. Said PTD send it identifier and the token to the Token Management Service. The Token Management Service establishes the link between the request and the PTD identifier. Said link is user to exchange information between the user, the Publisher, the Token Management Service, and the parties authorized by the above three.

### BRIEF DESCRIPTION OF DRAWINGS

FIG. 1 describes communication between the components of token-based information exchange system.

### DETAILED DESCRIPTION OF THE PREFERRED EMBODIMENT

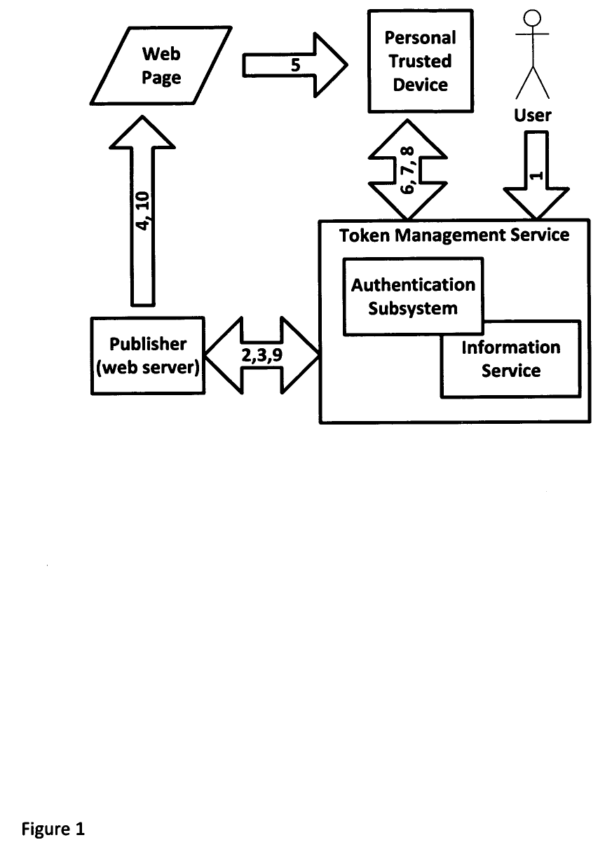

In this specific embodiment shown on FIG. 1 a user with PTD establishes a link between the

Publisher and the PTD

1. At a prior time a user logs into the Information Service and enters personal information (arrow 1).

2. For each web browsing session containing fillable forms a publisher (web server) sends a request for new token from Token Management Service wherein it specifies the information needed to fill the form (arrow 2).

3. Token Management Service issues a new token and sends it to the web server (arrow 3).

4. Web server inserts a graphical representation of the token as a two-dimensional barcode into the web page (arrow 4).

5. The token is scanned by a personal trusted device (arrow 5).

6. The PTD sends a message to the Token Management Service containing the scanned token and identifier of the PTD (arrow 6).

7. The Authentication subsystem authenticates the user by requesting, receiving, and verifying user credential from PTD (arrow 7 and 8).

8. The Token Management Service retrieves the requested information from the Information Service and passes it to the web server (arrow 9).

9. The web server updates the web page containing the form with information received at the previous step (arrow 10).

1. A token-based information exchange system comprised of:
Personal trusted device (PTD), which include but not limited to mobile phone, portable personal computer, camera, or a digital music player, possessing non-volatile memory capable of storing device identifier including but not limited to unique device identifying number (UDID) or digitally signed trust certificate; capable of capturing short digital sequences (tokens) by employing embedded capture devices including but not limited to optical camera and near-field communication device; capable of communicating via wireless or wired digital networks.
Plurality of Publishers, which include but not limited to users with PTDs, web services controlling visual display devices, personal computers controlling visual display devices, and point of sale terminals that are capable to request, present and allow users to capture with their PTDs the tokens supplied by Token Management Service.
Network-connected Token Management Service that communicates via wireless or wired digital network with the PTD and facilitates establishing links between a Publisher and a PTD by: generating unique tokens by Publisher's request, receiving messages from a PTD that contains the PTD identifier and the token captured; establishing link between said token and the PTD identifier; notifying publishers of said link; and facilitating bidirectional information exchange between the PTD and the Publisher.
